(19) United States
(12) Patent Application Publication
(10) Pub. No.: US 2019/0249790 A1
(43) Pub. Date: Aug. 15, 2019

(54) INFLATION VALVE CAP, INFLATION VALVE STRUCTURE, AND TYRE AND VEHICLE

(71) Applicant: HAMATON AUTOMOTIVE TECHNOLOGY CO., LTD, Zhejiang (CN)

(72) Inventors: Jianer ZHANG, Zhejiang (CN); Baoer ZHU, Zhejiang (CN)

(21) Appl. No.: 16/345,876

(22) PCT Filed: Oct. 28, 2016
(86) PCT No.: PCT/CN2016/103741

§ 371 Date: Apr. 29, 2019

(51) Int. Cl. F16K 15/20; B60C 29/06

(52) U.S. Cl. CPC F16K 15/205; F16K 27/08; B60C 29/066; F16K 15/207

(57) ABSTRACT

An inflation valve cap comprises a main body structure (1), a push rod structure, an elastic restoring member (4), and a push rod fixing base (6). The interior of the main body structure (1) is provided with a central cavity. The push rod structure is disposed inside the central cavity. The elastic restoring member (4) is arranged between the upper end of the push rod structure and the push rod fixing base (6). The push rod fixing base (6) is located at a lower portion of the central cavity. A bottom portion of the push rod structure is provided with a push rod seal (5), and in a non-inflated state, the push rod seal (5) presses against an inner inclined face at the middle portion of the inner cavity of the push rod fixing base (6), thereby achieving the sealing in the non-inflated state.

### FIELD OF TECHNOLOGY

The present application relates to the field of inflation valves, and specifically to an inflation valve cap, an inflation valve structure, a tyre and a vehicle.

### BACKGROUND

Due to the diversifications of the specification and structure of the rim, the mounting position of the inflation valve, and the position and orientation of the inflation valve mouth are different respectively for trucks and buses, so that the disassembly and assembly of the inflation valve cap are not easy and quick to operate manually when inflating and deflating the tyre or detecting the tyre pressure. The multi-function inflation valve cap is a type of inflation valve cap that is mounted at the mouth of the inflation valve to directly inflate and deflate the tyre, and detect the tyre pressure without disassembly, and to ensure the sealing of the inflation valve and act as a protection cap of the inflation valve when the valve core fails. At present, the disassembly-free inflation valve cap has already been on the market, and the principle of which is that a push rod penetrating the top of the cap is provided at the axis of the cap for opening the valve core and restoring under the effect of a spring.

Each of the three kinds of sealing caps currently on the market has functional defects. An A-type (only for describing different structures, but not for classifying specifications and types; the same below) sealing cap is shown in FIG. 1-FIG. 5. A push rod is inserted into the mouth end of the main body as shown in A1, and spun and pressed so as to be fixed, lacking dust-proof and air sealing functions. The diameter of the inner hole of the fixing base, as shown in the minimum ventilation section A2, is designed to be 2.5 mm for preventing the push rod from decline. The sectional area is only 1.767 mm², and the theoretical ventilation flow rate is 5.985 m³/h, which cannot meet the requirements (the inflation valve requires a ventilation flow rate≥7.2 m³/h at temperature of 20° C. and relative humidity of 65%). A B-type sealing cap is shown in FIG. 6-FIG. 10. As shown in B1, the contact between the push rod sealing ring and the acute angle of the inner hole in the main body is prone to damaging the sealing ring, causing a sealing failure; and the push rod sealing ring is at an upper position, which is prone to accumulating dust and fiber, resulting in an ineffective sealing. The minimum cross-sectional area of the air flow path shown in B2 is only 1.759 mm², and the theoretical ventilation flow rate is 5.957 m³/h, which cannot meet the ventilation flow rate≥7.2 m³/h. A C-type sealing cap is shown in FIG. 11-FIG. 15. The convex outer diameter of the fixing base shown in C1 is 5 mm, which is greater than the smaller diameter of the inner thread of the non-expanding inflation valve 5V1. The non-expanding inflation valve cannot be mounted in place and seal the inflation valve, and the contact width between the sealing ring and the valve opening is only 0.8 mm. Therefore, the structure is prone to be deformed after being pressed, causing a sealing failure. The push rod sealing ring shown in C2 has a relatively wide upper plane structure and the permanent indentation generated during use is extremely prone to causing the accumulation of foreign matter such as dust, hair, fibers and the like, resulting in a seal failure.

### SUMMARY

### (I) Technical Problems to be Solved

The present application aims to provide an inflation valve cap, an inflation valve structure, a tyre and a vehicle, so as to solve the problems that the sealing is poor and the dustproof function is ineffective.

### (II) Technical Solutions

In order to solve the technical problems above, the present application provides an inflation valve cap, including a main body structure, a push rod structure, an elastic restoring member and a push rod fixing base; wherein an interior of the main body structure is provided with a central cavity running from top to bottom along a central axis of the main body structure; the push rod structure is placed in the central cavity and can slide up and down along the central cavity, an upper end of the push rod structure seals an upper end opening of the central cavity, and a lower end of the push rod structure is located inside an inner cavity of the push rod fixing base; the elastic restoring member is provided between the upper end of the push rod structure and the push rod fixing base;

the push rod fixing base is located at a lower portion of the central cavity, a middle portion of the inner cavity of the push rod fixing base is gradually expanding from top to bottom; a push rod sealing element is provided at a bottom of the push rod structure, and the push rod sealing element abuts against an inner bevel of the middle portion of the inner cavity of the push rod fixing base under a non-inflated state.

In some embodiments, alternatively, two circumferential bosses are provided at a lower portion of the push rod structure, and the push rod sealing element is provided in a circumferential groove between the two circumferential bosses.

In some embodiments, alternatively, the push rod sealing element is an elastic annular sealing ring which is tightly clamped over the circumferential groove.

In some embodiments, alternatively, the elastic restoring member is a compression spring.

In some embodiments, alternatively, the push rod structure comprises a push rod and a push rod cap fixedly sleeved on an upper end of the push rod; a longitudinal section of the push rod cap is a “T”-shaped plane, and an upper surface of the push rod cap is higher than an upper surface of the main body structure.

In some embodiments, alternatively, the push rod cap is snapped into an upper portion of the central cavity, and a one-side gap between an outer side wall of a cap head of the push rod cap and an inner side wall of the central cavity is 0.04-0.08 mm.

In some embodiments, alternatively, the upper surface of the push rod cap is 0.5-1.0 mm higher than the upper surface of the main body structure.

In some embodiments, alternatively, the push rod cap is riveted and reinforced at the upper end of the push rod.

In some embodiments, alternatively, an outer side wall of a lower end of the push rod fixing base and a side wall of the central cavity of the main body structure constitute a mounting passage of a main body sealing ring therebetween, and a minimum cross-sectional width of the mounting passage is smaller than a cross-sectional diameter of the main body sealing ring.

In some embodiments, alternatively, the main body sealing ring is an O-shaped sealing ring.

In some embodiments, alternatively, an upper portion and a lower portion of the push rod fixing base are both cylindrical structures, and a cylinder diameter of the upper portion is smaller than a cylinder diameter of the lower portion.

In some embodiments, alternatively, an angle a between an inner bevel in a middle portion of the inner cavity of the push rod fixing base and a side surface of the upper portion of the push rod fixing base is 25° to 30°.

In some embodiments, alternatively, a distance between a bottom surface of the push rod and a bottom surface of the push rod fixing base is 1.2-1.6 mm under the non-inflated state.

In some embodiments, alternatively, a middle portion of the inner cavity is a frustum structure.

The present application also provides an inflation valve structure, including an inflation valve and the inflation valve cap above, wherein the inflation valve cap is sleeved on the inflation valve.

The present application also provides a tyre, wherein the inflation valve structure above is provided on the tyre.

The present application also provides a vehicle, wherein the tyre above is provided on the vehicle.

### (III) Advantageous Effects

For the inflation valve cap, the inflation valve structure, the tyre and the vehicle provided by the present application, under the non-inflated state, the elastic restoring member pulls the upper end of the posh rod and the push rod fixing base so that they get close, and the bottom of the push rod structure is provided with the push rod sealing element which abuts against the inner wall of the push rod sealing element, thereby the sealing under the non-inflated state is achieved. In addition, the middle portion of the inner cavity is gradually expending from top to bottom. During inflating, the air flows in the push rod fixing base from top to bottom, enters from the narrower diameter end, gradually disperses through the middle portion, and is discharged from a wider diameter end to form a structure with a tiny air inlet end and an open air outlet end. The air flow quickly passes through the push rod fixing base to prevent dust from being deposited on the push rod fixing base, thereby avoiding dust accumulation.

### BRIEF DESCRIPTION OF THE DRAWINGS

FIG. 1 is structural diagram of an A-type inflation valve cap in the prior art;

FIG. 2 is a structural diagram of the inflation valve cap in FIG. 1 when it is under an inflated state;

FIG. 3 is a schematic view showing the assembly of the A-type inflation valve cap of FIG. 1;

FIG. 4 is an enlarged schematic view of A1 in FIG. 1;

FIG. 5 is an enlarged schematic view of A2 in FIG. 1;

FIG. 6 is structural diagram of a B-type inflation valve cap in the prior art;

FIG. 7 is a structural diagram of the inflation valve cap in FIG. 6 when it is under an inflated state;

FIG. 8 is a schematic view showing the assembly of the B-type inflation valve cap of FIG. 6;

FIG. 9 is an enlarged schematic view of B1 in FIG. 6;

FIG. 10 is an enlarged schematic view of B2 in FIG. 6;

FIG. 11 is structural diagram of a C-type inflation valve cap in the prior art;

FIG. 12 is a structural diagram of the inflation valve cap in FIG. 11 when it is under an inflated state;

FIG. 13 is a schematic view showing the assembly of the C-type inflation valve cap of FIG. 11;

FIG. 14 is an enlarged schematic view of C1 in FIG. 11;

FIG. 15 is an enlarged schematic view of C2 in FIG. 11;

FIG. 16 is a structural diagram of the inflation valve cap according to an embodiment of the present application;

FIG. 17 is a structural diagram of the inflation valve cap in FIG. 16 when it is under an inflated state;

FIG. 18 is a schematic view showing the assembly of the inflation valve cap of FIG. 16;

FIG. 19 is an enlarged schematic view of I1 in FIG. 16;

FIG. 20 is an enlarged schematic view of I2 in FIG. 16;

FIG. 21 is an enlarged schematic view of I3 in FIG. 16;

FIG. 22 is a structural diagram of the push rod in FIG. 16;

FIG. 23 is a structural diagram of the push rod fixing base in FIG. 16;

FIG. 24 is a structural diagram of the push rod sealing ring.

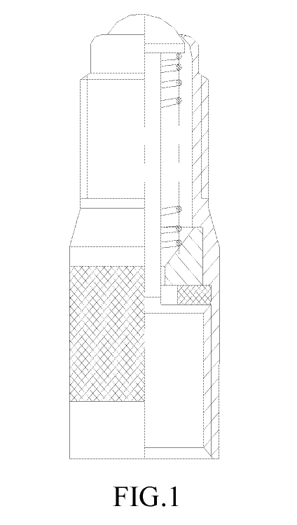

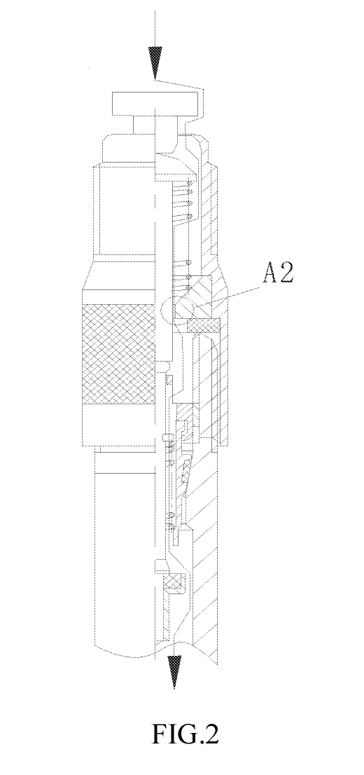

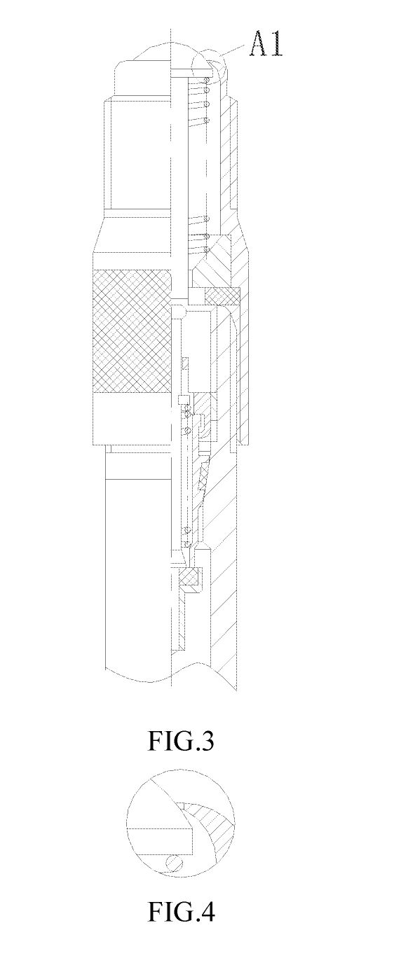

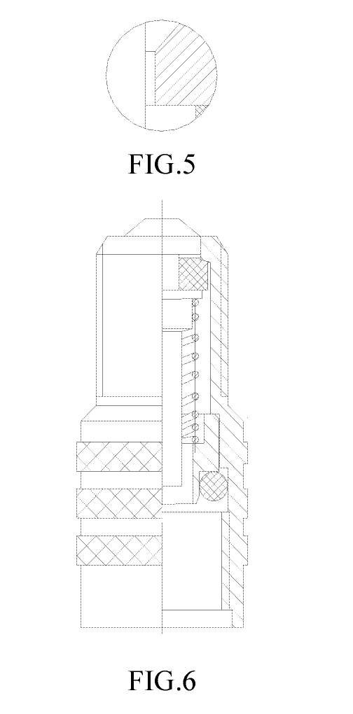

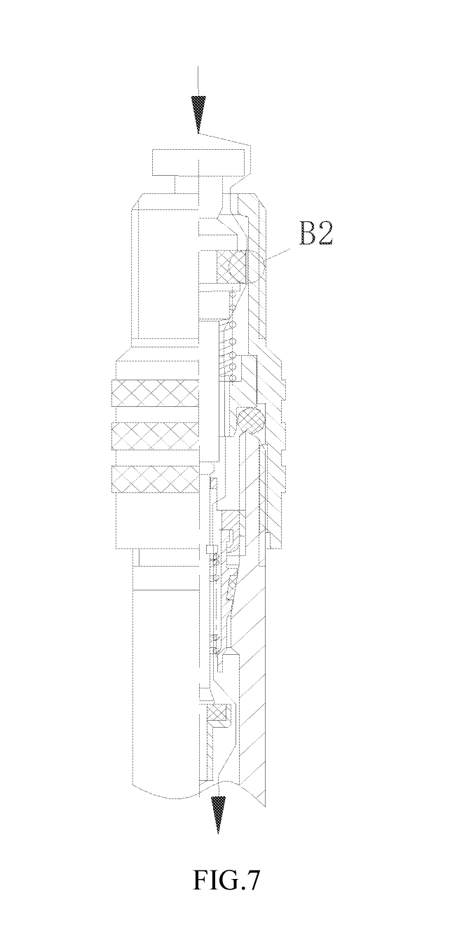

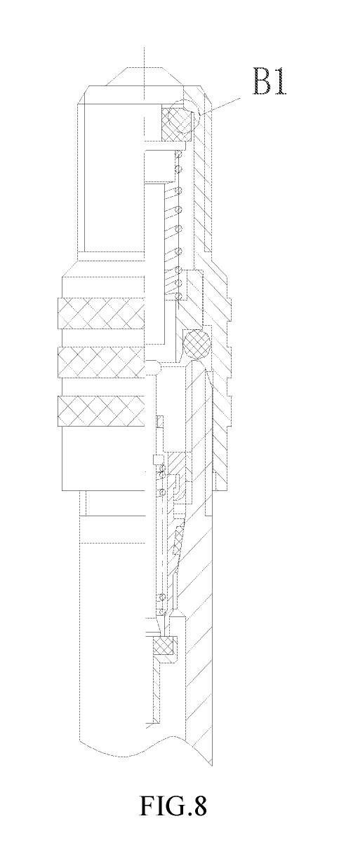

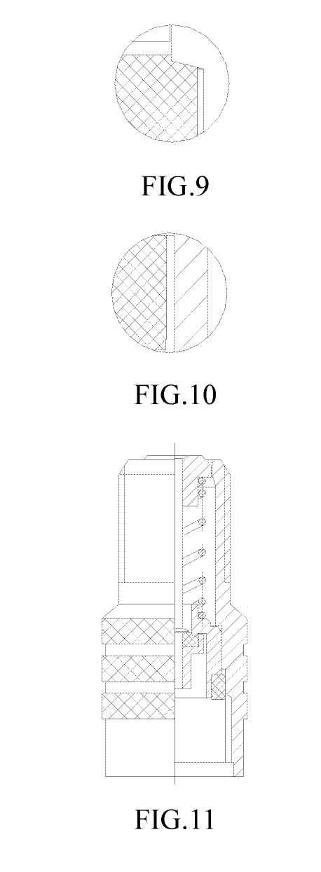

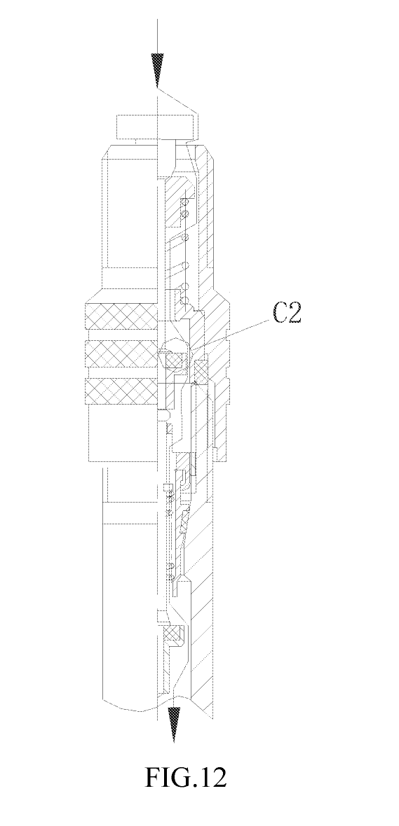

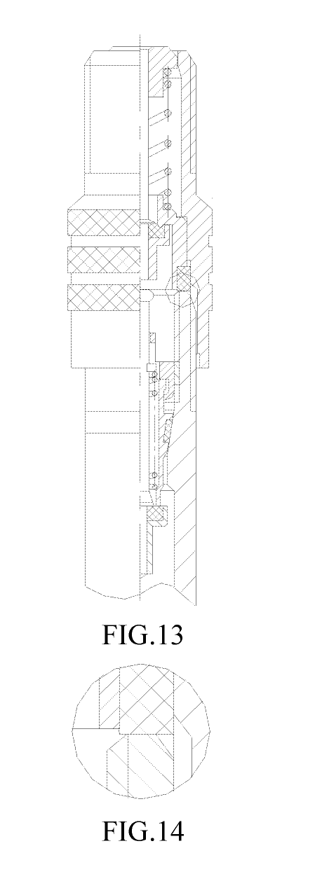

In the drawings:
1 main body structure;
2 push rod cap;
3 push rod;
4 compression spring;
5 push rod sealing ring;
6 push rod fixing base;
7 main body sealing ring;
8 valve core;
9 inflation valve.

### DETAILED DESCRIPTION

The specific implementations of the present application are further described in detail hereinafter with reference to the drawings and embodiments. The following examples are intended to illustrate the present application, but are not intended to limit the scope thereof.

In the description of the present application, it should be understood that the orientational or positional relations indicated by the terms “center”, “length”, “width”, “thickness”, “upper”, “lower”, “front”, “rear”, “left”, “right”, “vertical”, “horizontal”, “top”, “bottom”, “inner”, “outer”, etc. are based on the orientational or positional relations shown in the drawings, and are for the convenience of describing the present application and simplifying the description, but not indicating or implying that the referred device or component must have the specific orientations, be constructed and operated in the specific orientations, which therefore cannot be construed as limiting the present application.

Since the existing inflation valve caps have a poor sealing effect under an non-inflated state, and a sealing element is prone to deposit dust, resulting in an ineffective sealing, the present application provides an inflation valve cap, an inflation valve structure, a tyre and a vehicle.

Hereinafter, the present application is described in detail through basic designs, extended designs and replacement designs:

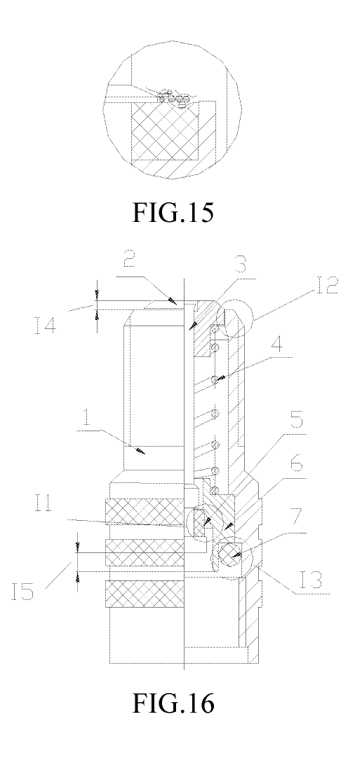

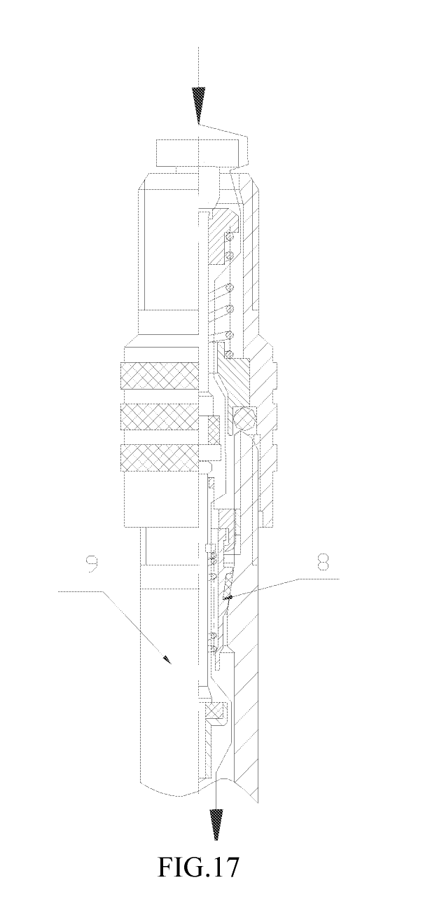

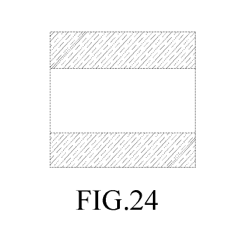

An inflation valve cap, as shown in FIG. 16-FIG. 24, is sleeved on an inflation valve, and is mainly composed of a main body structure 1, a push rod structure, an elastic restoring member and a push rod fixing base 6. An interior of the main body structure 1 is provided with a central cavity running from top to bottom along a central axis thereof. The push rod structure, the elastic restoring member and the push rod fixing base 6 are in the central cavity. The push rod structure is placed in the central cavity, an upper end of the push rod structure seals an upper end opening of the central cavity, and a lower end of the push rod structure is located inside an inner cavity of the push rod fixing base 6 which is located at a lower portion of the central cavity. As shown in FIG. 17, the push rod structure can slide up and down along the central cavity. When the upper end of the push rod structure is pressed downward, the push rod structure moves down and the push rod fixing base 6 is fixed so that an inflating path is opened for inflation. In order to facilitate the restoring of the push rod structure after inflation, an elastic restoring member is provided between the upper end of the push rod structure and the push rod fixing base 6. After inflation, the restoring force of the elastic restoring member pushes the push rod structure to restore into a dust-proof position.

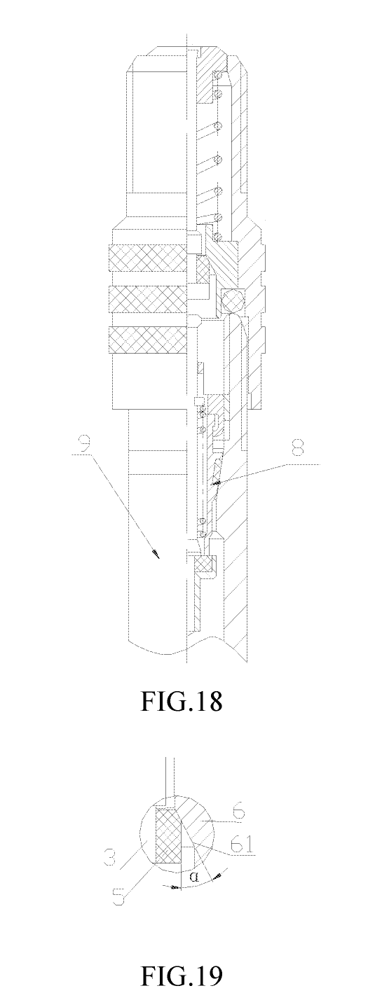

As shown in FIG. 18, in order to achieve a sealing under the non-inflated state, a bottom of the push rod structure is provided with a push rod sealing element. Under the non-inflated state, the push rod sealing element abuts against an inner wall of the inner cavity of the push rod fixing base 6, and the close contact between the push rod sealing element and the inner wall of the inner cavity of the push rod fixing base 6 closes an air flow path to achieve a sealing effect. Even if the valve core fails, the push rod sealing element can still achieve the sealing effect to prevent air leakage. In order to avoid dust deposition of the push rod sealing element, a middle portion of the inner cavity of the push rod sealing element is gradually expanding from top to bottom. An upper portion of the push rod sealing element has a narrower diameter, and a lower portion of the push rod sealing element has a wider diameter. The air flow flows from top to bottom, and flows in from the narrower opening and flows out from the wider opening. Since the air flow flows out quickly, the dust of the air flow is not prone to be deposited on the push rod sealing element.

The push rod sealing element moves as the push rod structure moves up and down. For this reason, in some cases, two circumferential bosses can be provided at the lower portion of the push rod structure, and the push rod sealing element is provided in a circumferential groove 31 between the two circumferential bosses, as shown in FIG. 22. In other words, the push rod sealing element is stuck in the circumferential groove and forms a structure with the push rod structure. In this structure, the push rod sealing element and the push rod structure move together.

Further, it should be noted that, in other embodiments, the specific installation and connection manners of the push rod sealing element and the push rod structure may be designed according to needs, and the design idea that the push rod sealing element and the push rod structure move together.

In order to achieve a better sealing effect, the push rod sealing element needs to have a certain elasticity so as to achieve a precise sealing by the buffering force thereof. Therefore, in some cases, the push rod sealing element adopts an elastic annular sealing ring sleeved over the circumferential groove. And in order to prevent the elastic annular sealing ring from sliding in the circumferential groove, the elastic annular sealing ring is tightly clamped over the circumferential groove.

It should be noted that the sizes of the groove and the elastic annular sealing ring can be determined according to the specific product, as long as the tightening effect is satisfied (determining the inner diameter of the elastic annular sealing ring), and under the non-inflated state, the push rod sealing element can abut against the side wall of the inner cavity of the push rod fixing base 6 (determining the height of the elastic annular sealing ring). For example, for vehicles currently in common use, the cross-sectional diameter of the circumferential groove is 1.2 mm, the inner ring diameter of the elastic annular sealing ring is 1 mm, the outer ring diameter is 2.6 mm, and the height is 1.6 mm.

When the push rod structure moves downward, the distance between the upper end of the push rod structure and the push rod fixing base 6 is shortened, the elastic restoring member is compressed and will generate a rebounding force. In some cases, the elastic restoring member may be a compression spring 4. The compression spring 4 has a stable elastic effect. The compression spring 4 is sleeved on the push rod main body 32 of the push rod structure, an upper end of the compression spring 4 is connected to a push rod cap 2 of the push rod structure, and a lower end of the compression spring 4 is connected to the push rod fixing base 6.

In other cases, the elastic restoring member may be a high-elasticity rubber ring to substitute the compression spring 4.

In order to better achieve the sealing effect between the upper end of the push rod structure and the main structure 1, the push rod structure is mainly composed of a push rod and a push rod cap 2 fixedly sleeved on the upper end of the push rod. The longitudinal section of the push rod cap 2 is a “T”-shaped plane, and an upper surface of the push rod cap 2 is higher than an upper surface of the main body structure 1, and they form a distance 14 to prevent dust or foreign matter from accumulating during use.

The size of the upper surface of the push rod cap 2 higher than the upper surface of the main body structure 1 is controlled to be 0.5-1.0 mm. The sealing effect is not ideal when the size is too small. And when the push rod cap 2 is too long, the stroke for the push rod structure to move downward to open the venting path is too long, which is inconvenient to operate.

Moreover, as shown in FIG. 20, the push rod cap 2 is snapped into an upper portion of the central cavity, and a one-side gap L between an outer side wall of the cap head of the push rod cap 2 and the inner side wall of the central cavity is 0.04-0.08 mm, such as 0.06 mm, so that the push rod can be smoothly opened and restored during operation meanwhile effectively prevent the dust and foreign matter from entering.

It should be noted that the sizes of the push rod cap 2 and the center cavity of the main body structure 1 can be determined according to the specific product. For example, for a vehicle currently in common use, a maximum diameter of the push rod cap 2 is between 5.08-5.12 mm, and the diameter of the upper end opening of the central cavity of the main body structure is between 5.16-5.2 mm, thereby forming a one-side gap which is between 0.04-0.08 mm.

In order to promote the synchronous movement of the push rod cap 2 and the push rod, the push rod cap 2 is riveted and reinforced at an upper end of the push rod.

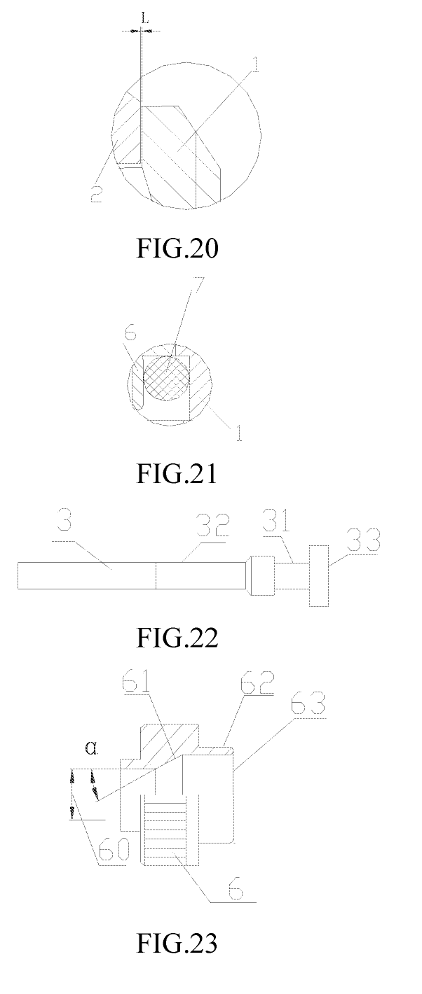

In some cases, as shown in FIG. 21, an outer side wall 62 of the lower end of the push rod fixing base 6 and the side wall of the central cavity of the main body structure 1 constitute a mounting passage of a main body sealing ring therebetween, and a minimum cross-sectional width of the mounting passage is smaller than a cross-sectional diameter of the main body sealing ring. The mounting position design of the main body sealing ring 7, as shown in FIG. 21, reliably fixes the main body sealing ring 7 at the mounting position, avoiding the main body sealing ring 7 falling off in the circulation.

In some cases, the main body sealing ring is an O-shaped sealing ring. In some cases, the size of the main body sealing ring 7 can be determined as desired. For example, for an existing conventional vehicle, the width of the mounting passage is 1.5 mm, and the cross-sectional diameter of the O-shaped sealing ring is 1.65 mm. Therefore, the O-shaped sealing ring is stuck in the mounting passage, and is not easy to fall off, and the sealing effect is obvious.

Based on the various designs above, as shown in FIG. 23, the upper portion and the lower portion of the push rod fixing base 6 are both cylindrical structures, and a cylinder diameter 60 of the upper portion is smaller than a cylinder diameter 63 of the lower portion. This structure is capable of forming a sufficient air flow path through which the air flow passes quickly, and it is difficult for dust to deposit on the push rod sealing element.

For example, a minimum diameter 32 of the push rod 3 is 1.1-1.2 mm. And as shown in FIG. 23, a minimum diameter 62 of the push rod fixing base 6 is 2.2-2.3 mm. When the minimum diameter of the push rod fixing base 6 is 2.25 mm, it constitutes a cross-sectional area 2.937 mm² of the smallest portion of air flow path of the double-sealed inflation valve cap of the present application. And by a theoretical calculation, the ventilation flow rate is 9.948 m³/h which meets the requirement that the ventilation flow rate of the inflation valve≥7.2 m³/h.

Under normal circumstances, the calculation formula for the ventilation flow rate is:

Ventilation flow rate=113 (compressible gas sound velocity transfer coefficient)×cross-sectional area mm²/×throttle reducing coefficient×initial air pressure Mpa

Corresponding to the above example:

Ventilation flow rate=113×2.9374×0.75×0.69×0.9653=165.81 L/mm²/=9.9486 m/h

After research and analysis, as shown in FIG. 19, an angle a between an inner bevel 61 in the middle portion of the inner cavity of the push rod fixing base 6 and a side surface of the upper portion of the push rod fixing base 6 is 25° to 30°, and the middle portion of the inner cavity is a frustum structure.

At the same time, in order to avoid the valve core being touched when the posh rod is moving downward, a distance 15 between a bottom surface of the push rod and a bottom surface of the push rod fixing base 6 is 1.2-1.6 mm in the non-inflated state, ensuring that the double-sealed inflation valve cap is mounted behind the inflation valve, and a lower end 33 of the push rod 3 keeps a distance 16 of 0.15 to 1.45 mm from the valve core, so that the push rod 3 will not touch the valve core, and can completely open the valve core when inflating.

For the multi-functional inflation valve cap of the present application, a one-way valve is constituted by the push rod cap 2, the push rod 3, the compression spring 4, the push rod sealing 5 and the push rod fixing base 6. The push rod moves upward and downward and restores normally, therefore an inflating means pushes the push rod so as to push the valve core to open for inflating or deflating without screwing off the cap. Verified through type tests:

(I) sealing test: mounting the double-sealed inflation valve cap on a test inflation valve (the valve core is not mounted on the inflation valve) with a torque of 0.3 Nm, putting it into a water tank together with the test tool, charging an air pressure of 1.4 Mpa, and the requirement is no leakage for 60 s. Closing the air supply and pressing the push rod 3 times with a stroke of 3 mm; and the restoration is required to be smooth and free of stagnation. Placing the test tool in the water tank again to observe that no bubble overflows. Placing the inflation valve cap that passed the room temperature test into a low temperature box of (−40-5)° C. together with the tool and test ethanol. During the test, compressed air at a low temperature is constantly pressed with 0.85 MPa, the time is 24 hours, and no bubble overflow was observed in 60 S. Placing the inflation valve cap that passed the low temperature test, together with the tool, into a high temperature box of 100+5° C. for 24 h, taking it out and immersing it in (60±5)° C. water, filling with compressed air of 0.85 Mpa, and it is observed that no bubble overflows at the connection of the opening end of the inflation valve cap and the inflation valve.

(II) ventilation flow rate test: mounting the double-sealed inflation valve cap of the present application on a gas flowmeter, inputting compressed air having a pressure of 0.69 MPa at temperature of 20° C. and relative humidity of 65%. It is measured that the ventilation flow rates are 11 m³/h, 11.3 m³/h and 11.6 m³/h.

(III) dust-proof test: mounting the double-sealed inflation valve cap of the present application on a special jig so that the 8V1 internal thread end is in a completely sealed state. The test is conducted in accordance with the foreign matter and dust infiltration code protection standard of 5K level in ISO 20653 standard. After the test, the normal temperature sealing test is performed with the jig, and it is observed that there is no leakage in 5 cycles (i.e., it is verified that there is no dust that leads to a sealing function failure is permeated).

(IV) vibration test: the test is carried out on an electric vibration tester. Axially fixing the double-sealed inflation valve cap of the present application on a test jig (the jig goes into the opening end of the sealing cap by ≤4 mm) in a same direction as the test displacement, sinusoidally vibrating for 2 min with a frequency of 8 to 10 Hz, and a displacement amplitude of 15 mm, and the vibration is repeated 3 times. Removing the sealing cap and it is observed that the sealing ring does not fall off.

In order to more sufficiently protect the technology, the inflation valve cap above is applied to an inflation valve to form an inflation valve structure, wherein the inflation valve cap is sleeved on the inflation valve.

In order to more sufficiently protect the technology, the inflation valve structure is applied to a tyre so as to form a new tyre.

In order to more sufficiently protect the technology, the tyre above is applied to a new vehicle.

The above is only preferred embodiments of the present application, which is not intended to limit the present application. Any modification, equivalent substitution, improvement, and etc., made within the spirit and principle of the present application should be within the protection scope of the present application.

### INDUSTRIAL APPLICABILITY

For the inflation valve cap, the inflation valve structure, the tyre and the vehicle provided by the present application, under the non-inflated state, the elastic restoring member pulls the upper end of the posh rod and the push rod fixing base so that they get close, and the bottom of the push rod structure is provided with the push rod sealing element which abuts against the inner wall of the push rod sealing element, thereby the sealing under the non-inflated state is achieved. In addition, the middle portion of the inner cavity is gradually expending from top to bottom. During inflating, the air flows in the push rod fixing base from top to bottom, enters from the narrower diameter end, gradually disperses through the middle portion, and is discharged from a wider diameter end to form a structure with a tiny air inlet end and an open air outlet end. The air flow quickly passes through the push rod fixing base to prevent dust from being deposited on the push rod fixing base, thereby avoiding dust accumulation.

1. An inflation valve cap, comprising a main body structure, a push rod structure, an elastic restoring member and a push rod fixing base; wherein an interior of the main body structure is provided with a central cavity running from top to bottom along a central axis of the main body structure; the push rod structure is placed in the central cavity and can slide up and down along the central cavity, an upper end of the push rod structure seals an upper end opening of the central cavity, and a lower end of the push rod structure is located inside an inner cavity of the push rod fixing base; the elastic restoring member is provided between the upper end of the push rod structure and the push rod fixing base;
the push rod fixing base is located at a lower portion of the central cavity, a middle portion of the inner cavity of the push rod fixing base is gradually expanding from top to bottom; a push rod sealing element is provided at a bottom of the push rod structure, and the push rod sealing element abuts against an inner wall of the inner cavity of the push rod fixing base under a non-inflated state.

2. The inflation valve cap of claim 1, wherein two circumferential bosses are provided at a lower portion of the push rod structure, and the push rod sealing element is provided in a circumferential groove between the two circumferential bosses.

3. The inflation valve cap of claim 2, wherein the push rod sealing element is an elastic annular sealing ring which is tightly clamped over the circumferential groove.

4. The inflation valve cap of claim 1, wherein the elastic restoring member is a compression spring.

5. The inflation valve cap of claim 1, wherein the push rod structure comprises a push rod and a push rod cap fixedly sleeved on an upper end of the push rod; a longitudinal section of the push rod cap is a “T”-shaped plane, and an upper surface of the push rod cap is higher than an upper surface of the main body structure.

6. The inflation valve cap of claim 5, wherein the push rod cap is snapped into an upper portion of the central cavity, and a one-side gap between an outer side wall of a cap head of the push rod cap and an inner side wall of the central cavity is 0.04-0.08 mm.

7. The inflation valve cap of claim 5, wherein the upper surface of the push rod cap is 0.5-1.0 mm higher than the upper surface of the main body structure.

8. The inflation valve cap of claim 5, wherein the push rod cap is riveted and reinforced at the upper end of the push rod.

9. The inflation valve cap of claim 1, wherein an outer side wall of a lower end of the push rod fixing base and a side wall of the central cavity of the main body structure constitute a mounting passage of a main body sealing ring therebetween, and a minimum cross-sectional width of the mounting passage is smaller than a cross-sectional diameter of the main body sealing ring.

10. The inflation valve cap of claim 9, wherein the main body sealing ring is an O-shaped sealing ring.

11. The inflation valve cap of claim 1, wherein an upper portion and a lower portion of the push rod fixing base are both cylindrical structures, and a cylinder diameter of the upper portion is smaller than a cylinder diameter of the lower portion.

12. The inflation valve cap of claim 11, wherein an angle between an inner bevel in a middle portion of the inner cavity of the push rod fixing base and a side surface of the upper portion of the push rod fixing base is 25° to 30°.

13. The inflation valve cap of claim 11, wherein a distance between a bottom surface of the push rod and a bottom surface of the push rod fixing base is 1.2-1.6 mm under the non-inflated state.

14. The inflation valve cap of claim 11, wherein a middle portion of the inner cavity of the push rod fixing base is a frustum structure.

15. An inflation valve structure, comprising an inflation valve and the inflation valve cap of claim 1, wherein the inflation valve cap is sleeved on the inflation valve.

16. A tyre, comprising the inflation valve structure of claim 15, wherein the inflation valve structure is provided on the tyre.

17. (canceled)
